(19) United States
(12) Patent Application Publication
(10) Pub. No.: US 2009/0012841 A1
(43) Pub. Date: Jan. 8, 2009

(54) EVENT COMMUNICATION PLATFORM FOR MOBILE DEVICE USERS

(75) Inventors: Keith David Saft, San Francisco, CA (US); Chris W. Higgins, Portland, OR (US); Marc E. Davis, San Francisco, CA (US); Joseph J. O'Sullivan, Oakland, CA (US); Robert Carter Trout, Menlo Park, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 12/038,716

(22) Filed: Feb. 27, 2008

Related U.S. Application Data
(63) Continuation-in-part of application No. 11/651,102, filed on Jan. 5, 2007.

(51) Int. Cl. G06Q 30/00; G06F 15/16

(52) U.S. Cl. 705/10; 709/201; 705/14

(57) ABSTRACT

A method, system, and apparatus are directed to communicating data over a network. Event attributes comprising at least two of a temporal, spatial, social, or topical information are received. An event structure comprising fields associated with a different one of a temporal, spatial, social, or topical dimension based on the received event attributes is generated. An advertising attributes about an advertisement is received. The advertising attributes may comprise at least two of another temporal, spatial, social, or topical information. If the event structure matches the advertising attributes, the advertisement may be provided co-located with the event structure. The advertisement may be configured to provide a value exchange if the advertisement is activated.

### CROSS-REFERENCE TO RELATED APPLICATIONS

This application is a continuation-in-part of U.S. patent application Ser. No. 11/651,102, filed Jan. 5, 2007, which is hereby incorporated by reference in its entirety.

### FIELD OF ART

The present invention relates generally to searching data and, more particularly, but not exclusively to managing and providing event information over a network.

### BACKGROUND

Tremendous changes have been occurring in the Internet that influence our everyday lives. For example, in today's society, mobile computing devices are becoming increasingly more common. Many mobile computing devices, such as personal digital assistants, cellular phones, and the like, may be employed to communicate voice messages, emails, text messages, and so forth, as well as to search for information over the Internet. It is not uncommon to see a person on a bus, train, or even a boat, to be using their mobile devices to search for merchants, restaurants, music, businesses, or the like.

However, performing a search query for user relevant information still remains cumbrous. Often, the user might have to perform several search queries to obtain relevant search results. Irrelevant search results mean that the user is less likely to find when they are looking for, which in turn may translate into lost opportunities for merchants, or other businesses, to prosper from the user. Therefore, many businesses are searching for new ways tog make search results more relevant to the user. One technique is to group search results that match submitted search terms. Some search systems provide predefined groups of data types for search results, such as web pages, images, videos, local results, shopping related results, jobs, news, advertisements, and the like. The groups are typically arranged in the same order and each group typically includes only one data type.

Another technique is to determine groups based on textual similarity of the search results However, textually similar groups generally do not take into account any information about the searcher. Consequently, the groups that are determined by textual similarity may not be the most relevant groups to the searcher. Similarly, a ranking of textually similar groups may not be in an order that is most relevant to the searcher. Current grouping systems also generally provide only brief summary information and links to the search results. A returned search results page generally does not include any substantive content without links based on the search terms.

Moreover, users of mobile devices often manage a variety of events in their lives, including ad-hoc events, online events, predetermined events such as meetings, or the like. A variety of tools, both online and offline are available for managing events. However, event management with these tools may be cumbersome and entering events into mobile devices may be error prone. Moreover, searching for relevant or interesting events may be problematic. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a server device that may be included in a system implementing the invention;

FIG. 4 shows one example of a search results page for a topical search term that is related to relatively intuitive concepts to determine search results;

FIG. 5 shows one example of a search results page for a search term that is related to less intuitive concepts to determine search results;

FIG. 6 illustrates a logical flow diagram generally showing one embodiment of an overall process for searching data;

FIG. 7 illustrates a logical flow diagram generally showing one embodiment of a process for determining concept-specific data sources;

FIG. 8 illustrates a logical flow diagram generally showing one embodiment of a process for modifying cluster scores on clusters of search results;

FIGS. 9-10 illustrate logical flow diagrams generally showing embodiments of processes for managing an event;

FIG. 11 illustrates a flow diagram generally showing an embodiment of generating an event structure based on event attributes;

FIG. 12 illustrates a flow diagram generally showing an embodiment of matching an advertisement to an event structure;

FIG. 13 illustrates a flow diagram generally showing an embodiment for managing advertisements for events; and

FIG. 14 illustrates a flow diagram generally showing an embodiment providing event information.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “event attribute” refers to conceptual and contextual information about an occurrence. Event attributes may be temporal, spatial, social, or topical information, or other information about a user, a user's behaviors, or the like. Topical information may include any concept. Event attributes may also comprise contextual information, such as time, place, date, and conceptual information, such as information about topical s, ideas, or the like. Information about the state of devices associated with the user may be used to determine the event attribute.

In some embodiment, event attributes may include any two or more of the temporal, spatial, social, or topical information. For example, event attributes may include topical and temporal information, e.g., the event attributes are about a logical event such as an online writing contest. Other event attributes may include social, temporal, and spatial information about, for example, a real-world at a specific time and for a specific duration with a known set of users.

Briefly, one embodiment of the present invention is directed to a clustered search processing. Clustered search processing may comprise searching data and grouping search results into clusters that are ordered according to search relevance. Each cluster comprises one or more data type, such as images, web pages, local information, news, advertisements, and the like. In one embodiment, a search term is evaluated for related concepts indicating categories of data sources to search. Data sources may also be identified by context information such as a location of a client device, a currently running application, and the like. Search results in each cluster are ordered by relevance and each cluster is given a score based on an aggregate of the relevance within the cluster. Each cluster score may be modified based on one or more corresponding concepts and/or context information. The clusters are ordered based on the modified scores. Content, including advertisements, may also be added to the ordered list to appear as another cluster.

Briefly, another embodiment of the present invention is directed to communicating data about an event over a network. Event attributes comprising at least two of a temporal, spatial, social, or topical information are received from a device and a web usage. The device may be a mobile device. Advertising attributes about an advertisement are received and are otherwise managed. The advertising attributes may comprise at least two of another temporal, spatial, social, or topical information.

In one embodiment, an event structure may be generated before a search is performed on the event attributes and/or information derived from the event attributes. In this embodiment, the event structure is generated with fields associated with a different one of a temporal, spatial, social, or topical dimension based on the received event attributes. In one embodiment, the event structure may be generated based on clustering data points comprising the event attributes. The event structure is also associated with the advertisement, if the event structure matches the advertising attributes.

The event structure is searched for based on a match with attributes associated with the user and/or a received search term. The search may be a clustered search processing and may be based on conceptual and/or contextual information associated with the user. The event structure is provided co-located with the advertisement. The advertisement may be configured to provide a value exchange if the advertisement is activated.

In an alternate embodiment, the event structure may be generated after a search is performed. In this embodiment, the event attributes are searched for based on a match with attributes associated with the user and/or the received search term The search may be a clustered search processing. An event structure may be generated based on the matched/searched event attributes. The event structure is also associated with the advertisement, if the event structure matches the advertising attributes. The event structure and/or advertisement are provided. In one embodiment, parameters for performing subsequent searching/matching and/or generating may be modified based on a match between the provided event structure and the search term and/or the user.

### Illustrative Operating Environment

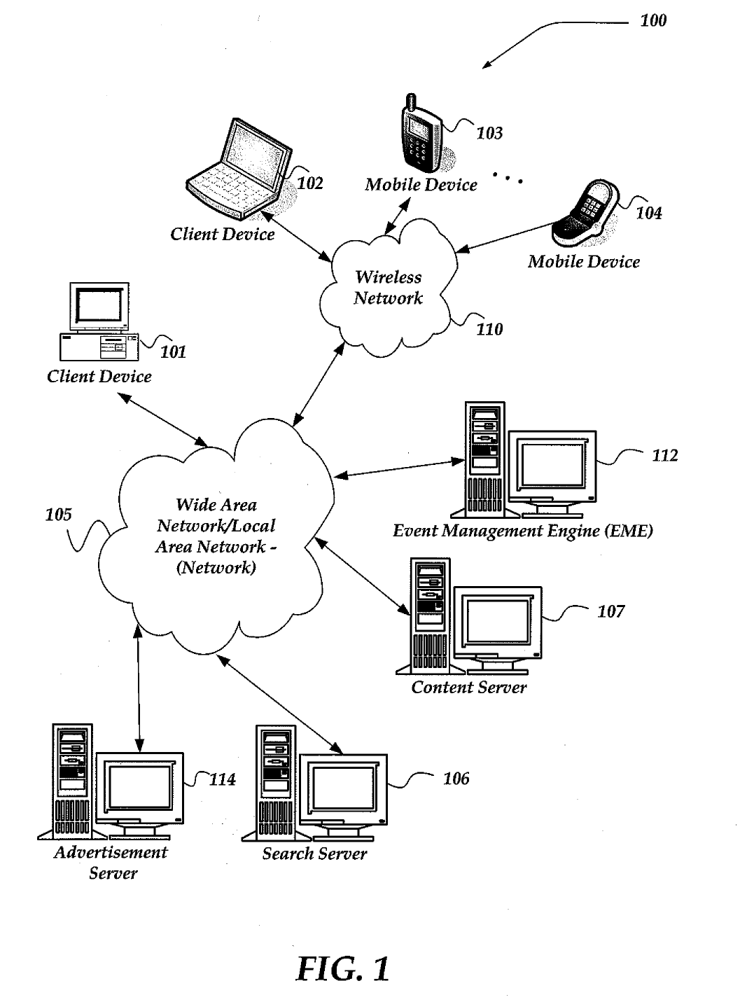

FIG. 1 shows components of one embodiment of an environment in which the invention may be practiced. Not all the components may be required to practice the invention, and variations in the arrangement and type of the components may be made without departing from the spirit or scope of the invention, As shown, system 100 of FIG. 1 includes networks that enable communication between client and server devices. A network 105 may comprise one or more local area networks (“LANs”) and/or wide area networks (“WANs”). A wireless network 110 may comprise LANs, WANs, telephony networks, or the like. System 100 also includes a general purpose client device 101, mobile client devices 102-104, a search server 106, and content server 107.

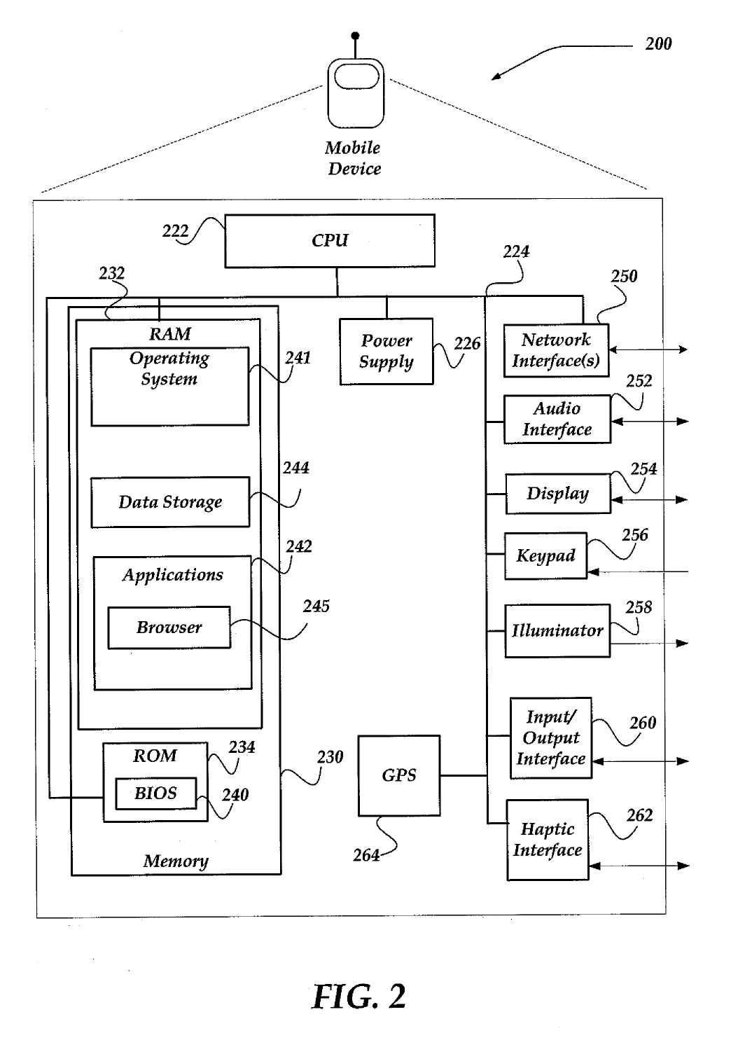

One embodiment of mobile devices 102-103 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the mobile device may employ the browser application to perform a search over a network. However, another application may also be used to perform a search over the network.

Mobile devices 102-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to search server 106, client device 101, or other computing devices.

In one embodiment, mobile devices 102-104 may also provide a physical location to another computing device. In one embodiment, however, mobile devices 102-104 may provide the physical location information in terms of latitude and longitude, or the like. However, mobile devices 102-104 may also provide other information that may be employed to determine a physical location of the device, including for example, a cell tower address, a MAC address, IP address, or the like.

Mobile devices 102-104 may further be configured to include a client application that enables the end-user to log into an end-user account that may be managed by another computing device, such as search server 106. Such end-user account, for example, may be configured to enable the end-user to receive emails, send/receive IM messages, SMS messages, access selected web pages, participate in a social networking activity, perform search queries, or the like. However, performing search queries, participation in various social networking activities, or the like, may also be performed without logging into the end-user account.

Client device 101 may include virtually any computing device capable of communicating over a network to send and receive information, including search query information, location information, social networking information, or the like. The set of such devices may include devices that typically connect using a wired or wireless communications medium such as personal computers, multiprocessor systems, microprocessor-based or programmable consumer electronics, network PCs, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include cellular networks, mesh networks, Wireless LAN (WLAN) networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple search server 106 and its components with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between search server 106, client device 101, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

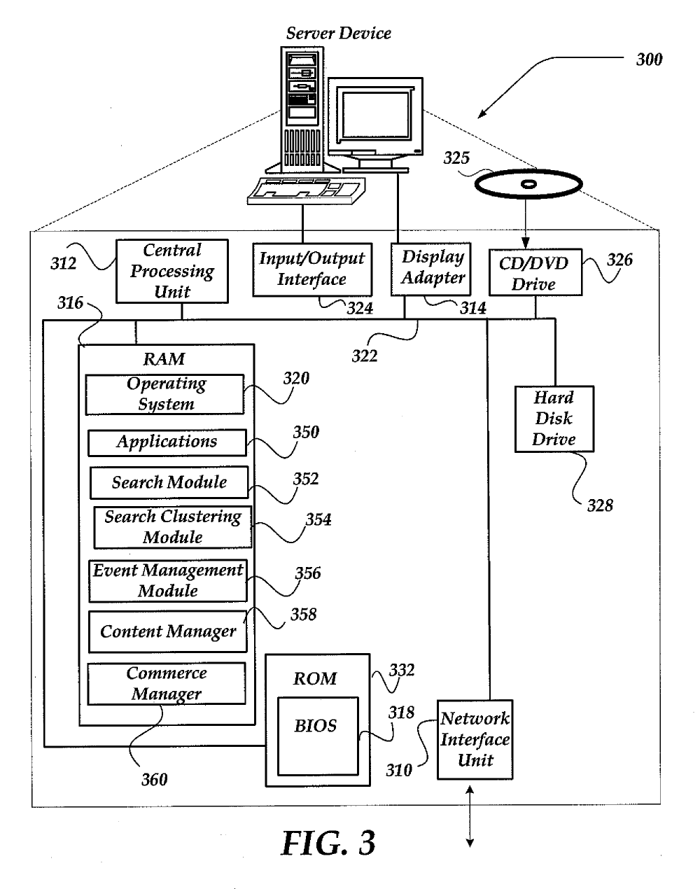

One embodiment of search server 106 is described in more detail below in conjunction with FIG. 3. Briefly, however, search server 106 may include any computing device capable of connecting to network 105 to enable data searching, filtering, sorting, and other data management operations. Search server 106 may also provide network portal information and/or services, including providing content and tracking users online behavior with their permission. Search server 106 may further enable aggregation and management of social networking information. Devices that may operate as search server 106 include personal computers desktop computers, multiprocessor systems, microprocessor-based or programmable consumer electronics, network PCs, servers, and the like.

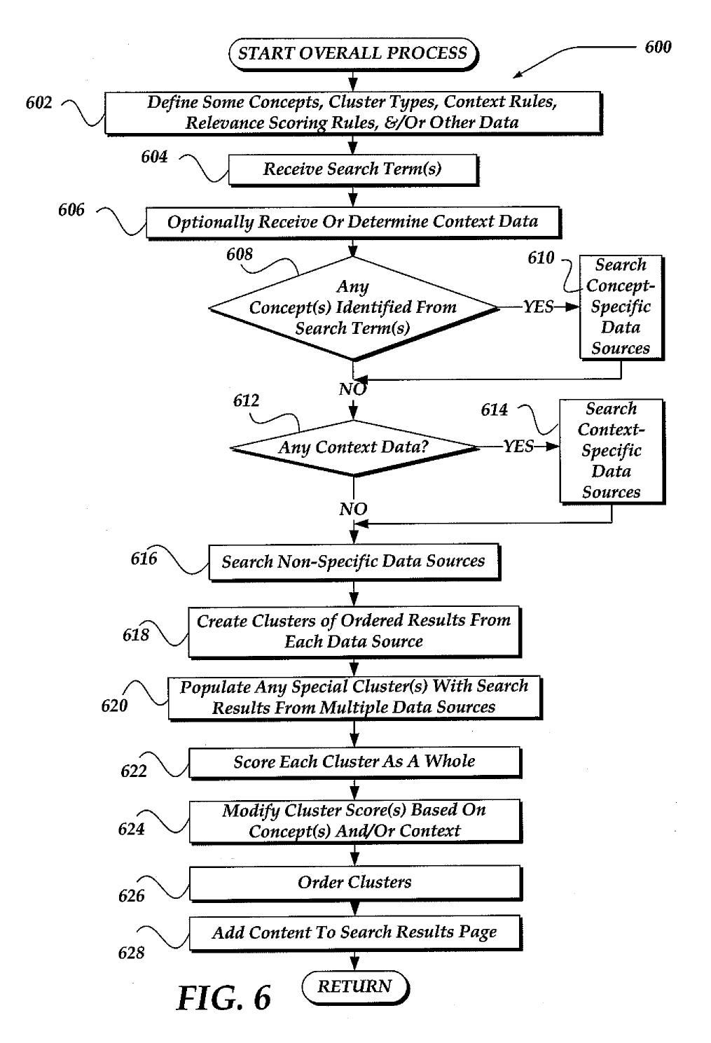

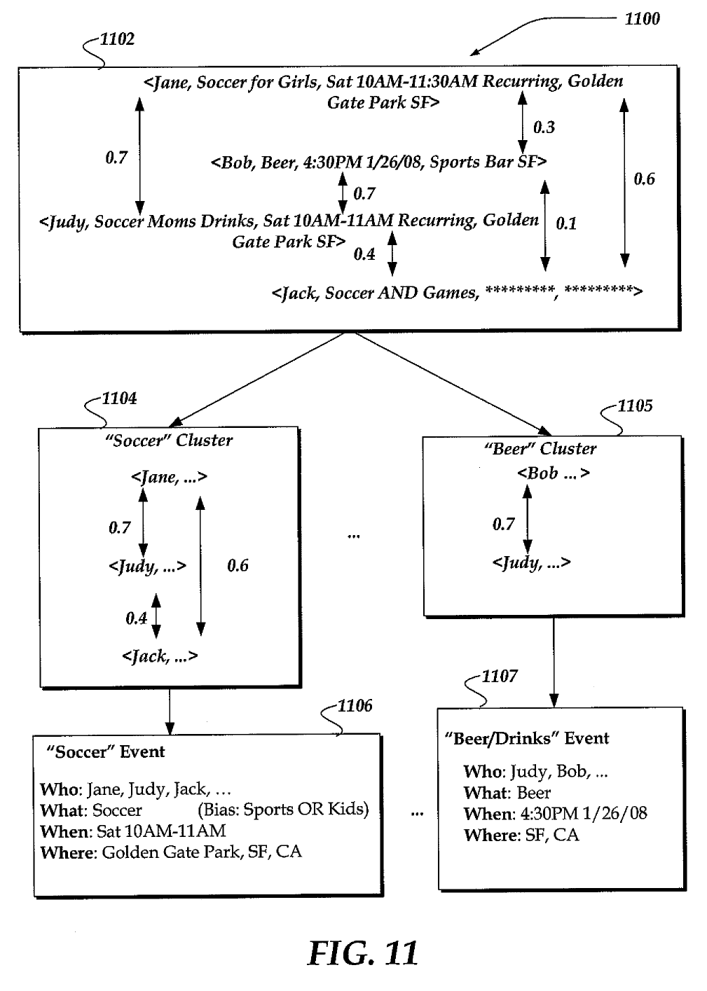

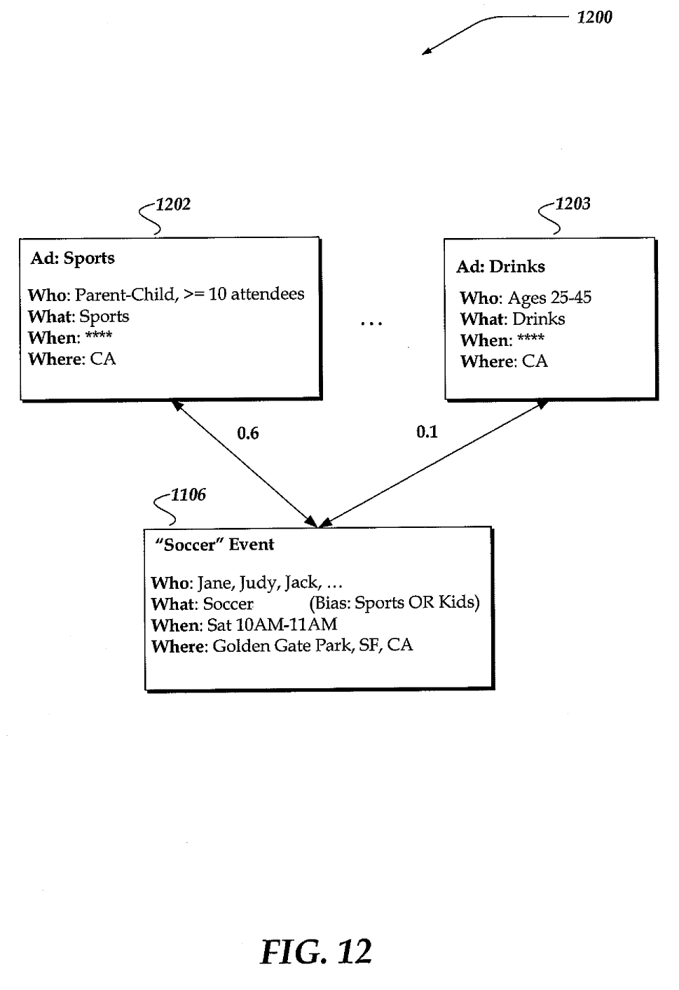

Event management engine (EME) 112 is described in more detail below in conjunction with FIG. 3. EME 112 may use processes described in conjunction with FIGS. 6-12 to perform at least some of its operations. In one embodiment, EME 112 may be configured to provide, receive, manage, or generate event attributes to generate at least one event structure, and may be further configured to provide the event structure to client devices 101-104 over networks 105-110. An event structure is described in more detail in conjunction with FIGS. 11-12. The event structure may be provided in a plurality of formats, including search results, event micro-site (e.g., name, title, and attributes of the event), results in a geographical map with event points located at the location of the event, events located within a timeline, or the like.

EME 112 may provide event services for a plurality of types of users. A user may comprise an event-specific user such as an Attendee, Organizer/Staff, Sponsor, Exhibitor, Presenter, Press, User proxy or other sponsored user or local resource. In one embodiment, a user may specify that they are a type (Attendee, Organizer, etc) associated with the event. In another embodiment, the type of the user may be determined based on categorizing a user's interaction with an event. The categorization may be rule-based. For example, a rule may determine that a user is an attendee if the user matches an event at a high factor, is a sponsor, if the user matches at a lesser factor, or the like. In another embodiment, if a user is periodically spatially near an event, they may be determined to be an attendee. In another embodiment, if the user is continuously (e.g., over a period of time) at an event, such as for several months, then the user may be determined to be a facility, organizer, or the like. Many other rules or heuristics may be used to determine the user and grant them different permissions to use EME 112 without departing from the scope of the invention.

In one embodiment, EME 112 may provide end-to-end management of events. In one embodiment, before an event begins, EME 112 may provide a planning process for an event. During an event, EME 112 may provide a real-time event service of specialized content, people matching, commerce programs, or the like. After an event, EME 112 may provide post-event content updating, commerce services, community hosting services, or the like. In one embodiment, EME 112 may provide a self-serve event personalization and monetization web application for providing do-it-yourself tools to create, register, and run an event. In another embodiment, the EME 112 may provide a closed service to event Organizers or Sponsors and may include a revenue-sharing arrangement among any of the relevant parties including Organizer, Event location or Facilities providers, wireless or wired providers, EME 112 operator, Experts, Exhibitors, Presenters, or the like.

An event structure can be generated and/or otherwise provided by an organizer, exhibitor, facilities-owner, local vendor or a other entity that controls a piece of real estate at an event, e.g. ATM, bathroom, coffee stand, or the like. Client device 101 may be used by the entity, for example, to send information about its location, content/service/topic, or to capture user actions and environmental conditions at the location of client device 101. For example, client device 101 may be at a facility and may be configured to respond intelligently to actual visitors or network-based users and may facilitate automated exchange or collection of information.

In one embodiment, users of client devices 101-104 may be restricted from accessing EME 112 based on their permission level, whether they are authorized for a transaction, or the like. In one embodiment, EME 112 may enable a user of client devices 101-104 to create an event structure. The event structure may be associated with event-specific trigger words to enable content clustering and personalization of search results to a user's mobile devices. For example, an event structure may be biased to enable clustering on the topical, “Daytona 500” during the weekend of the Daytona 500 race. In another embodiment, the EME 112 may enable an organizer user to enter information for a specific event, e.g., through a web-based application configuring a specific event structure. In one embodiment, the specific event may be provided in a micro-site on demand for the event or for organizer's association, or the like.

In another embodiment, the EME 112 may provide a matching service based on for example, topical, activity, session information, or the like. Matching people to event information comprises matching attributes of users (e.g., temporal, spatial, topical al, social attributes) to an event's attributes. Matching may comprise matching an expert user on a topical to an event about a topical, matching a person employed by an organizer of an event (event staff) to the event, matching a user to at least one of 1) a local special offer spatially near the user, 2) a user attending, sponsoring, or staffing an event, 3) another event of similar topical s, 3) another user of the event, 4) another user associated with another event of the same type as the event (e.g., attendee to attendee, sponsor to sponsor, etc.), or the like. Matching may also comprise matching a user associated with an event to at least one of 1) an event staff, 2) exhibitor, 4) expert on a topical, 5) another user giving a presentation at the event, 6) a local resource, 7) exclusive content about the event, or the like. Such matching may be automatically provided and pushed to one of client devices 101-104 of the user, or the like. In another embodiment, the user may request the matching, based on, for example, sending a request for matched information, a search request, or the like.

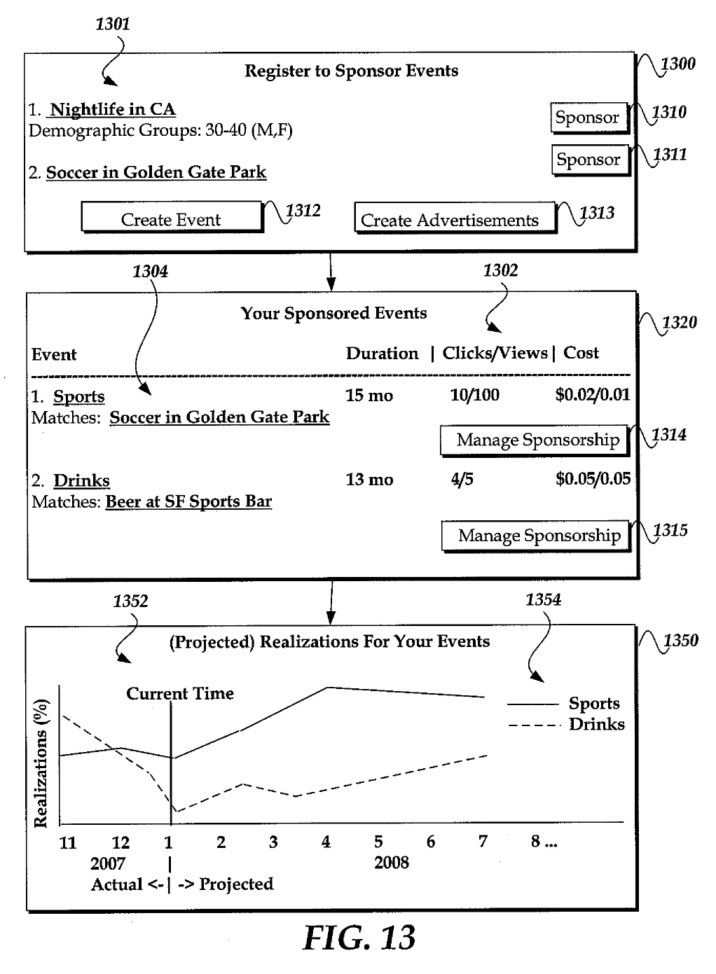

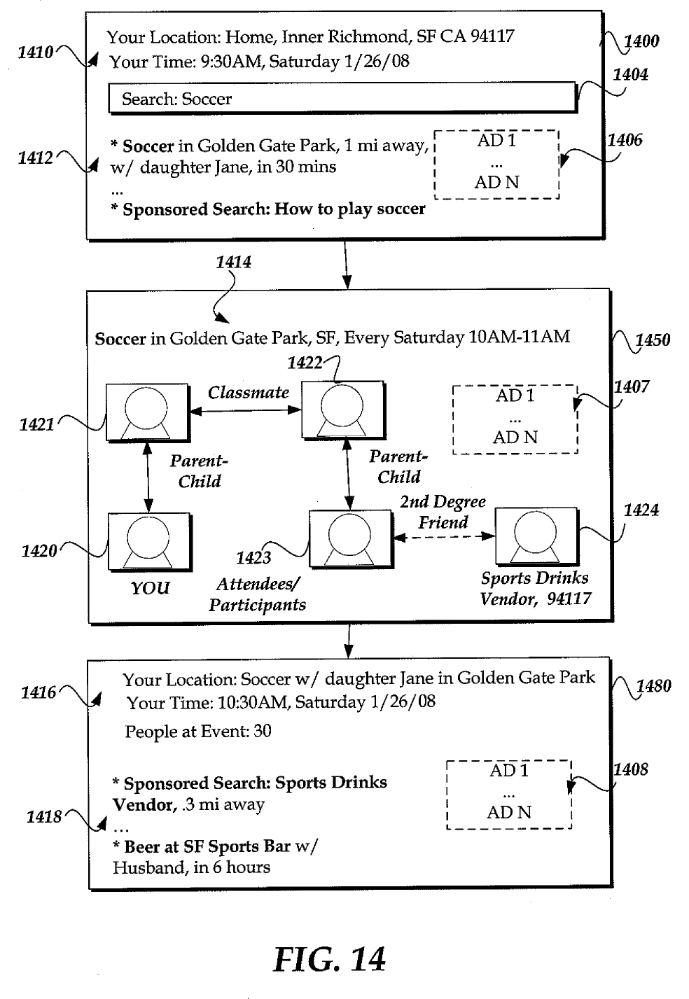

Advertisement server (AS) 114 includes any device configured to manage and/or provide advertising and sponsorship information. In one embodiment, AS 114 may provide an advertiser using one of client devices 101-104 an interface (e.g., web interface) for entering in an advertisement, an advertising campaign, or the like. The advertisements may comprise event attributes including temporal, spatial, social, or topical information. The advertisements may be biased to information based on the provided information. An illustrative advertisement data structure is described in more detail in conjunction with FIG. 12. A process and illustrative displays for managing advertisements are described in more detail in conjunction with FIG. 13. AS 114 may send an advertisement to search server 106, content server 107, and/or EME 112. The advertisement may be associated with event attributes, event structures, or the like. In one embodiment, the advertisement may be associated with event information before and/or after a user searches or requests the event information. The advertisement and associated event information may be provided to a user on one of client devices 101-104. A process for providing the advertisement is described in conjunction with FIG. 14. In one embodiment, activating the advertisement may enable a revenue exchange between a sponsor/advertiser and another party. In one embodiment, at least a portion of the revenue may be sent to a user attending, sponsoring, or otherwise associated with the event.

Although FIG. 1 illustrates search server 106 as a single computing device, the invention is not so limited. For example, one or more functions of search server 106 may be distributed across one or more distinct computing devices. For example, managing searches, search results, Instant Messaging (IM) sessions, SMS messages, email messages, sharing of contact information, collecting behavior information, aggregating, and/or storing of social networking information, or the like, may be performed by a plurality of computing devices, without departing from the scope or spirit of the present invention.

Content server 107 represents a variety of content and/or other data that may useable on mobile devices 102-104 and/or on client 101. Such content may include web content, audio content, video content, FTP data, or the like. Data services may include, but are not limited to web services, third-party services, audio services, video services, email services, IM services, SMS services, VOIP services, calendaring services, photo services, or the like. Moreover, information about the content and/or services provided by content server 107 may be employed to provide results to a search query.

Devices that may operate as content server 107 include personal computers desktop computers, multiprocessor systems, microprocessor-based or programmable consumer electronics, network PCs, servers, and the like.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, one embodiment of at least one of mobile devices 102-104 of FIG. 1.

As shown in the figure, mobile device 200 includes a central processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UVWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions. In another embodiment, illuminator 258 may comprise a flash for a built-in camera (not shown).

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), Enhanced Observed Time Difference (E-OTD), cell identifier (CI), service area identifier (SAI), enhanced timing advance (ETA), base station subsystem (BSS), or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, the mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a specialized client communication operating system such as Windows Mobile™, or the Symbian® operating system, or a general purpose operating system such as a version of UNIX, or LINUX™. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store search data, user preferences, address books, buddy lists, aliases, social networking information, or the like. At least a portion of the information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. One application shown in the figure is browser 245.

Browser 245 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may be employed.

In one embodiment, browser 245 may be configured to enable access to a search application, such as might be available through search server 106 and/or content server 107 of FIG. 1. In one embodiment, a user of mobile device 200 may input to the search application a variety of search terms for use in obtaining a search results. Mobile device 200 may also provide location information, or information useable in determining its physical location. Such information, may, in one embodiment, be useable to automatically (e.g., transparent to a user input) modify the search query.

In another embodiment, browser 245 may be configured to enable access to an event management application, such as might be available through EME 112, SAS 114, search server 106, and/or content server 107 of FIG. 1. In one embodiment, a user of mobile device 200 may send to the search application a variety of search terms for use in obtaining at least one event structure displayed in a plurality of ways. In one embodiment, the event structure may be displayed as a search result. In another embodiment, browser 245 may be configured to automatically pull an event structure based on information about mobile device 200 (e.g., location, time) and/or a user of mobile device 200.

### Illustrative Server Environment

FIG. 3 shows one embodiment of a server device, according to one embodiment of the invention. Server device 300 may include many more components than those shown. The components shown, however, are sufficient to disclose an illustrative embodiment for practicing the invention. Server device 300 may represent, for example, search server 106, and/or content server 107 of FIG. 1.

Server device 300 includes a central processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of server device 300. Any general-purpose operating system may be employed. Basic input/output system (“BIOS”) 318 is also provided for controlling the low-level operation of server device 300. As illustrated in FIG. 3, server device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. A search module 352 and/or a search clustering module 354 may also be included as an application program within applications 350 or as a separate application.

Search module 352 is configured to receive search terms from client devices, determine other search parameters, perform searches of data sources, provide search results, and perform other search related operations. Search clustering module 354 may be part of, or separate from search module 352. Search clustering module 354 is configured to organize search results into groups and rank the groups of results. Search module 352 and/or search clustering module 354 may employ a process substantially similar to that described below.

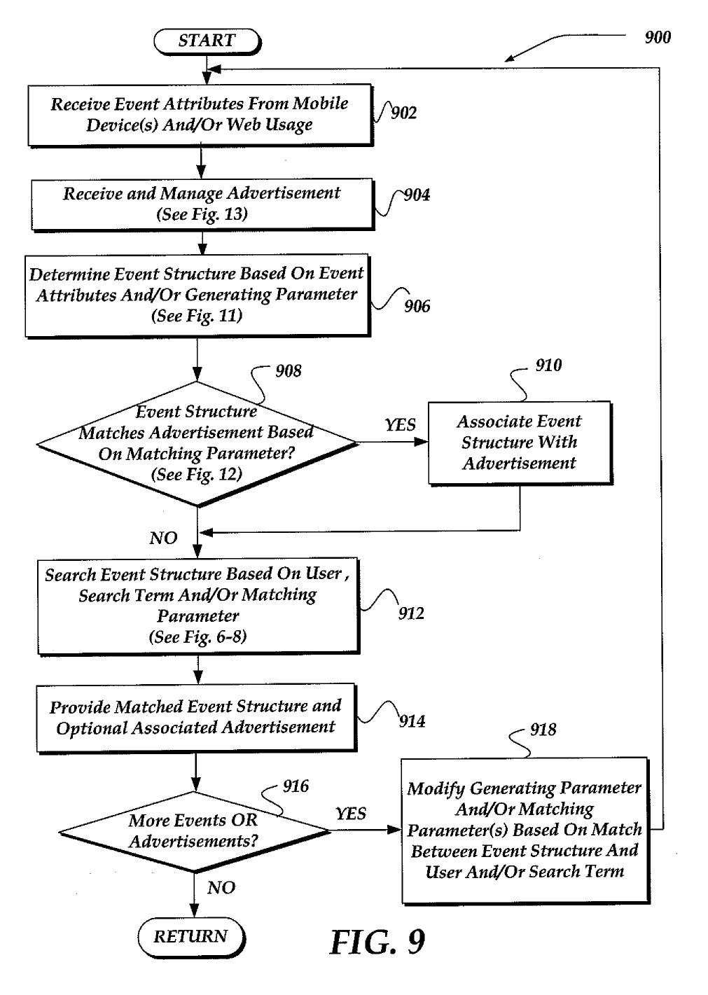

Event management module (EMM) 356 is configured to manage event processing. Processes for actions performed by EMM 356 are described in more detail in conjunction with FIGS. 9-12. Briefly, in one embodiment, EMM 356 may receive event attributes over network interface unit 310. The event attributes may be from and/or about client devices, about users of the client devices, web usage, time, location, or the like.

In one embodiment, EMM 356 may enable a user such as an organizer to register an event, its details, and details about known users associated or related with the event, as well as a specialized or exclusive content for the event. In one embodiment, an event organizer may upload relevant content and data for their event, when the event occurs, a type of the event (e.g. sporting event or technical conference), or the like.

An event structure can be generated and/or otherwise provided over network interface 310, using for example, a network protocol, such as HTTP, XML-RPC, or the like. For example, a physical facility, such as a vendor may provide event attributes. For example, a vendor may provide through network interface 310, a temporal (when the vendor is open), spatial (address), social (identity of the owner of the vendor in a social network), and topical (what the vendor sells) information.

In another embodiment, the event may be created as an event structure. In one embodiment, the event structure may be created as an empty event. In another embodiment, the event structure may be created with bias/parameters for the fields of the event structure. For example, the topical field of the event structure may be biased to be about “soccer” or “sports.”

Content manager 358 may enable the event structure to be populated with data, either manually from the user or automatically from event attributes. The process of automatically populating the event structure is described in more detail in conjunction with FIG. 11. Briefly, content manager 358 may index the event attributes. Content manager 358 may create a set of relations among the event attributes (e.g., content and user information). The relations may comprise a distributed graph mapping the content and users into groups of clusters. In one embodiment, the clusters may be associated with a keyword related to the event. In one embodiment, the clusters may be further refined into an event structure. Content manager 358 sends the event structure, graph, keyword attributes, clusters, and the like to the Commerce Manager 360.

Commerce Manager 360 may internally house or externally contact a sponsored ad server, such as advertisement server 114 of FIG. 1, over network interface unit 310 to, for example, generate a prioritized list of sponsors and sponsored content for the event structure or cluster, as appropriate. The process for matching an event structure with an advertisement/sponsor is described in more detail in conjunction with FIG. 12.

Commerce Manager 360 and/or content manager 358 may keep the event clusters, structures, associations with advertisers and/or sponsors updated as information about the events and users changes. In one embodiment, the update may be performed in real-time or substantially in real-time.

In one embodiment, EMM 356 may restrict access to the event to users associated with, attending or otherwise interested in the event. In one embodiment, the restriction may be managed by the organizer.

In one embodiment, EMM 356 may receive a request from the user for information about the event (e.g., event structure). In one embodiment, the user may search for an event and/or request a real-time event service, specialized content delivery, or modification, people matching (e.g., automatic, facilitated or manual), sponsored link activation, or request for commerce. In any case, the event information and an associated advertisement may be provided over network interface unit 310 to a user.

### Generalized Operation

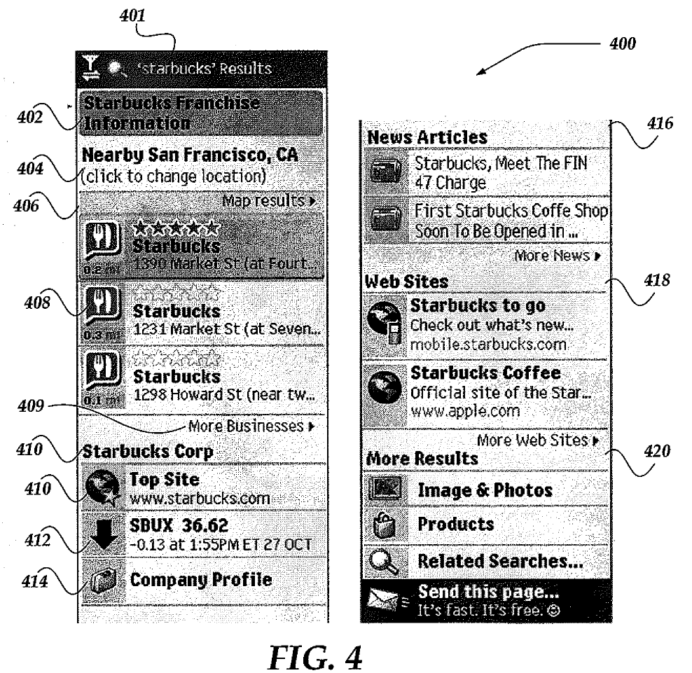

The operation of certain aspects of the invention will now be described with respect to FIGS. 4-8. FIG. 4 is an illustration of a search results display 400 on a mobile device. The entire search results may be scrolled through a display of limited area. In addition to search results, content can be displayed among the search results. Content may include information related to a submitted search term 401, such as content 402. Alternatively, or in addition, content may include location information 404, an advertisement, or other information. Generally, content information is formatted to appear similar to search results, although content may be formatted in any other way.

A first cluster element 406 indicates a first cluster of search results. The cluster element may be selected to toggle between an expanded view of search results and a closed view of only the cluster element. The cluster element may also comprise a search result itself. The first cluster of search results is displayed near the top of results display 400. The first cluster generally includes search results that are most relevant to the submitted search term. A cluster includes search results of one or more particular data types, such as local listing information, news articles, web page links, images, shopping information, other suggested searches, and the like. For example, first cluster element 406 indicates a cluster of local listing information for coffee stores identified by the search term and within a predefined radius of a mobile device location. In this example, local listing information was determined to be the most relevant cluster of information based on a number of factors, such as the search term, information determined from aggregate analysis of click streams (selections made by numerous users) after entering the search term, prior behaviors of the user in during the search term, location of the mobile device, and/or other information. This particular search term 401 is associated with the concept of retail stores and with the concept of a company. However, the concept of retail stores is likely to have a higher relevance to more users than the concept of a company. Thus, the cluster of local listing information is ranked as the first cluster.

The search results of a cluster can also include content indicating a data type or other information. For instance, a symbol 408 can indicate a type of information provided in the search result. In addition, or alternatively, a logo or other content may be placed on one or more search results, such as based on a paid placement. A selectable expansion control element 409 can be used to display additional results in a cluster.

A second ranked cluster is displayed after the first ranked cluster. In this example, a second rank cluster element 410 identifies a cluster that includes multiple data types of search results. This sample cluster includes a web site search result 410, a stock quote search result 412, and a link to specialized company profile information 414. This cluster illustrates a cluster type that is defined to include multiple specific data types. Alternatively, a cluster type can be generated with multiple data types that may be determined based on search criteria and/or other information. As shown by the second ranked cluster, customized cluster types can be defined to include multiple data types of search results and/or content.

Other cluster types may include a single data type of search results, such as the first rank cluster, third-ranked cluster 412, and fourth ranked 414. In those cases, the cluster type may be equivalent to the date type. Lower rank clusters may also be displayed with fewer search results, or with only space a cluster selection element. For example, low ranked clusters 416 are displayed with only cluster selection elements that require the user to select a cluster selection element to expand the view of corresponding search results. Thus, the relevance of clusters can be indicated by location, size, and other attributes.

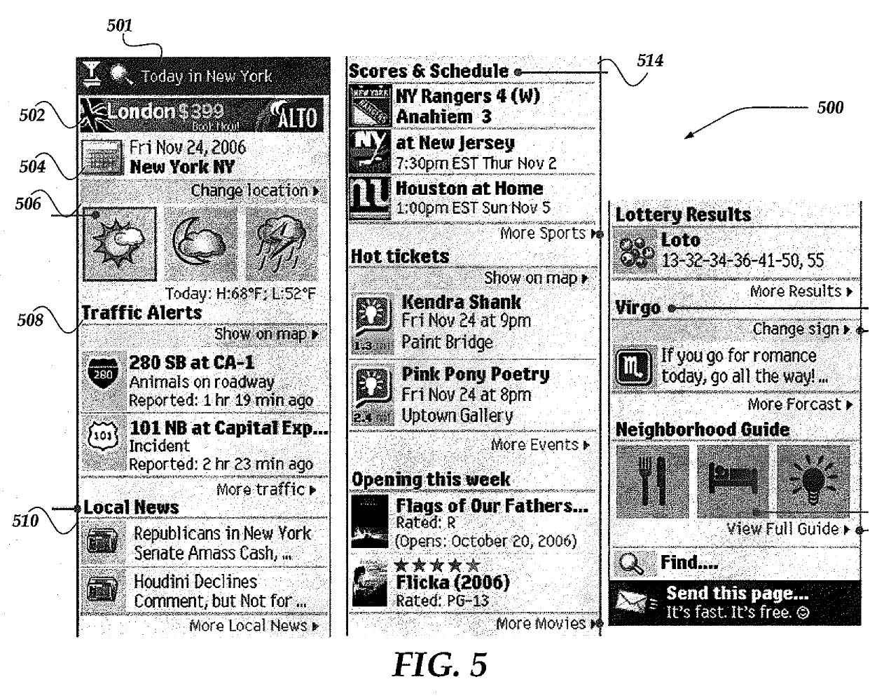

The search term used in FIG. 4 is generally a topical search term that is related to relatively intuitive concepts. Some search terms are not so intuitive. FIG. 5 shows one example of a search results page 500 for a search term 501 that is less intuitively related to concepts for which a user would likely want search results. The search term “today,” by itself, may not immediately suggest certain data types of search results that a user probably desires. This search term may indicate a concept of a newspaper title, a morning television show, or other unrelated concept. In this case, contextual information, such as the location of the mobile device, may provide a better indication of the user's intent. Thus, context information may be given more weight to determine which data sources to search and how to rank clusters of search results. If the mobile device is in New York City, and the user enters the search term “today,” the user is likely to be searching for information relevant to daily life in the city.

Such information may include content related to this city on the current day. For example, date content 504 may provide the current date and enable the user to access a calendar. Similarly, whether or information 506 may display current and forecasts weather conditions in the city. One or more advertisements 502 may also be included. Each of these content items may be obtained from a specialized data source or from an individual data source in the same manner that clusters of search results are obtained. This content cluster, or each content item, can also be ranked relative to other clusters as if the content cluster or content item were just another cluster among the plurality of clusters of search results. In this case, the content information may be considered the first ranked cluster. A traffic alerts cluster 508 would be considered the second ranked cluster. Similarly, local news cluster 510 would be the third ranked cluster, sports cluster 514 would be the fourth ranked cluster, and so on. The clusters of search results may not have data types that are intuitively associated with the search term, but contextual data can be used to obtain and rank clusters of relevant search results.

FIG. 6 illustrates a logical flow diagram generally showing one embodiment of an overall process 600 for searching data and ranking clusters of search results and/or content. The process may be performed by a server, a combination of servers, a standalone computing device, and/or other configurations of software modules and/or computing devices. To simplify the discussion, the following embodiment is described in terms of a single server in communication with a single mobile client device. At an operation 602, a human administrator may predefined certain concepts, cluster types, data types, concept processing rules, context rules, relevance scoring rules, and/or other information that may be used to determine data sources, rank search results, rank clusters of search results, add content, determine user preferences, determine user behaviors, and/or perform other operations. Alternatively, or in addition, automated analyses can be performed to determine one or more of the above information types, operational rules, and/or other data. For example, clicked stream analysis can be performed on aggregated data to determine multipliers and/or other factors that may be used in determining the resources and/or ranking information. In another embodiment, no such preprocessing is performed.

At an operation 604, the server receives one or more search terms from the mobile device. To simplify the discussion, a single search term will be assumed. Iterative processing and/or other logic can be used in alternate embodiments. The server may also receive, or obtain, context data at an operation 606. For example, the server may check a user's current location, the current application running on the mobile device, the mobile device profile data, online profile data for preferences, behaviors, past purchases, social networking relationships, and/or other user-specific data. Similarly, the server may obtain or calculate aggregated data from click stream analyses and/or other statistical analyses. The contextual information can be used to adjust default weighting multipliers prior to and/or during search processing. In another embodiment, no contextual data is received or determined. Some additional examples of contexts may include, but are not limited to:
web page or screen of the client device used to submit the search term
tracked behavior of a user (e.g. purchase history, number of searches)
user-specific data (e.g. demographic data such as gender)
time of day at the time of query
time zone of the user
search query characteristics (e.g. language, length of query, media type)
data plan of the device or user
device capabilities or characteristics (e.g. screen size)
user expressed preferences (e.g. don't render images)
proximity (e.g. to other devices or other users)
direction of the device (e.g. device is facing north)
movement of the device (e.g. device is going north, device is moving at 10 mph)
tracked behavior or other context of users related to user initiating search;
social network (e.g. user A's friends search for sports, so sports are more relevant for user A)
network characteristics (e.g. speed)
content owned by the user or on a device used by the user, which can be, but does not have to be the same as the mobile device (e.g. user has a document on their PC relevant to a search done on the mobile device)

At a decision operation 608, the server determines whether any known concepts are identified from the submitted search term. The server may perform a lookup operation for concepts associated with the search term, or may perform other interpretations, such as natural language processing, to determine concepts. Concepts generally identify categories of information related to the search term. For example, the search term “Chicago” is related to the concept of a city and the concept of a play. As another example, the search term “Chicago pizza” is related to the concept of a style of pizza and the concept of food in the city of Chicago.

Each concept may be associated with one or more particular data sources. For instance, play or movie schedules for local theaters may be in specific data sources that would not normally be searched unless it is determined that the user intends the search term to be associated with a play or movie. Other examples of concept-specific data sources may include, but are not limited to:

| | | |
|---|---|---|
| web | stock quote data | part inventory data |
| wap | dates/personals | photos |
| image | dictionary | plane schedules |
| photos | email | podcasts |
| video | entertainment | printed materials |
| local listings | encyclopedia | products |
| news | events | ringtones |
| weather | ferry schedules | RSS |
| multimedia | finance | screensavers |
| address books | flight status | shopping |
| astrology | games | sports |
| audio | inventory | thesaurus |
| books | job | time |
| bus schedules | landmarks | timezones |
| celebrities | lottery | train schedules |
| cities | movie show times | translations |
| classifieds | movie theaters | traffic |
| consumables | movies | TV showtimes |
| countries | music | wallpapers |
| currency | people | venues |

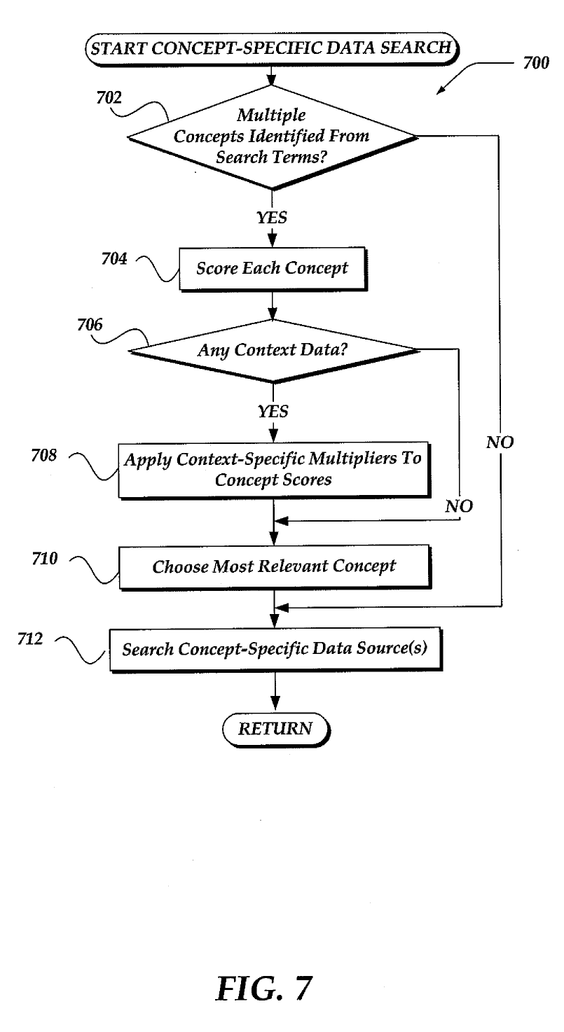

Each concept-specific data source may include a single data type of data, such as all stock quote data. Alternatively, a concept-specific data source may actually comprise multiple data sources with the same or differing data types. If the server identifies any concepts from the search term, the server searches corresponding concept-specific data sources at an operation 610. More details on one embodiment of the concept-specific search process are provided below with regard to the description of FIG. 7. The search results from each concept-specific data source comprises a cluster of search results. The cluster type of a cluster may be the same as the data type or a custom cluster type of multiple data types.

After searching concept-specific data sources, or if no concepts were identified, the server determines whether any context data was submitted or is available, at a decision operation 612. If context data is available, the server looks up or determines associations between the context data and context-specific data sources. The server searches the associated context-specific data sources at an operation 614. The search results from each context-specific data source comprises another cluster of search results. As above, a context-specific data source may include a single data type of data, such as all restaurant listings within a certain radius of the mobile device's current location. Alternatively, a context-specific data source may comprise multiple data sources with the same or differing data types. Accordingly, the cluster type of a cluster may be the same as the data type or a custom cluster type of multiple data types.

After searching context-specific data sources, or if no context data was available, the server search is nonspecific data sources at an operation 616. Nonspecific data sources may comprise data that will always be searched, such as web page indices, news data, images, shopping data, and the like. At an operation 618, the server orders the results in each cluster of search results obtained from each data source. The search results within a cluster are generally rank based on relevance of the search results to the search term. A number of techniques may be used to rank the search results within a cluster. Weighting factors, rules, and/or other processing may utilize aggregate click stream data, user's specific click stream data, user behavior information, and/or other information. In some cases, special clusters are populated with search results from multiple data sources and rank, at an operation 620.

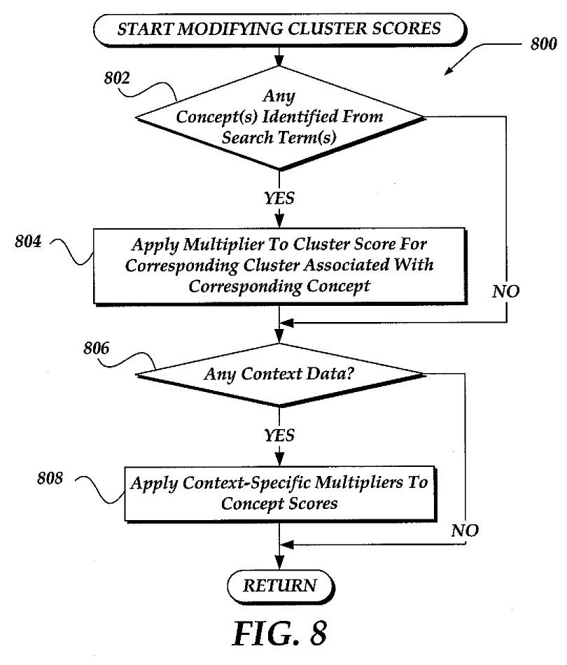

At an operation 622, the server determines a score for each cluster as a whole. The server may determine a cluster score with relevance scores of the search results within the cluster. For example, the server may determine a weighted average based on a cumulative score of the relevance scores and based on a predefined, or dynamically determined, factor. Each cluster score may be modified an operation 624, based on concepts and or context data. Further detail regarding this operation is described below with regard to FIG. 8. All of the clusters are then arranged in an order at an operation 626, based on the cluster scores.

In this example embodiment, a search results web page is generated with the ordered clusters, such as those web pages illustrated in FIGS. 4 and 5. Additional content, such as non-cluster advertising, logos, and/or other content may be added to the search results web page at an operation 628. The search results web page is then returned to the mobile device for display.

Further detail is now provided regarding operation 610. FIG. 7 illustrates a logical flow diagram generally showing one embodiment of a process 700 for determining and searching concept-specific data sources. At a decision operation 702, the server determines whether or multiple concepts were identified from the search term. If only a single concept was identified, the server searches the corresponding concept-specific data source at an operation 712. If multiple concepts were identified, the server determines a score for each concept at an operation 704. As with the cluster score, a concept score can be determined based on relevance of the concept to the search term and/or based on aggregate analyses.

And a decision operation 706, the server checks whether or any context data was received or determined. If context data is available, the server applies context-specific multipliers to the concept scores. The multipliers may be predefined or dynamically determined to indicate a relevance of each concept to each context.

After modifying the concept scores, or if no context data is available, the server determines the most relevant concept, at an operation 710. The server may select a single most relevant concept or may rank the concepts. At an operation 712, the server searches one or more concept specific data sources associated with the most relevant concept. Alternatively, the server may search concept-specific data sources for each of the ranked concepts. To simplify the discussion, this example embodiment chooses the most relevant concept and searches a single corresponding concept-specific data source. The search results comprise a concept-specific cluster.

Further detail is now provided regarding operation 610 of FIG. 6. FIG. 8 illustrates a logical flow diagram generally showing one embodiment of a process 800 for modifying cluster scores. At a decision operation 802, the server checks whether any concepts were identified from the search term. If a concept was identified, the server applies a multiplier, at an operation 804, to the cluster score of a corresponding cluster that is associated with the concept.

After applying a concept multiplier, or if no concepts were identified, the server checks whether or any context data is available, at a decision operation 806. If context data is available, the server applies one or more context-specific multipliers to the concept scores. The modified concept scores are then returned for subsequent ordering of the clusters.

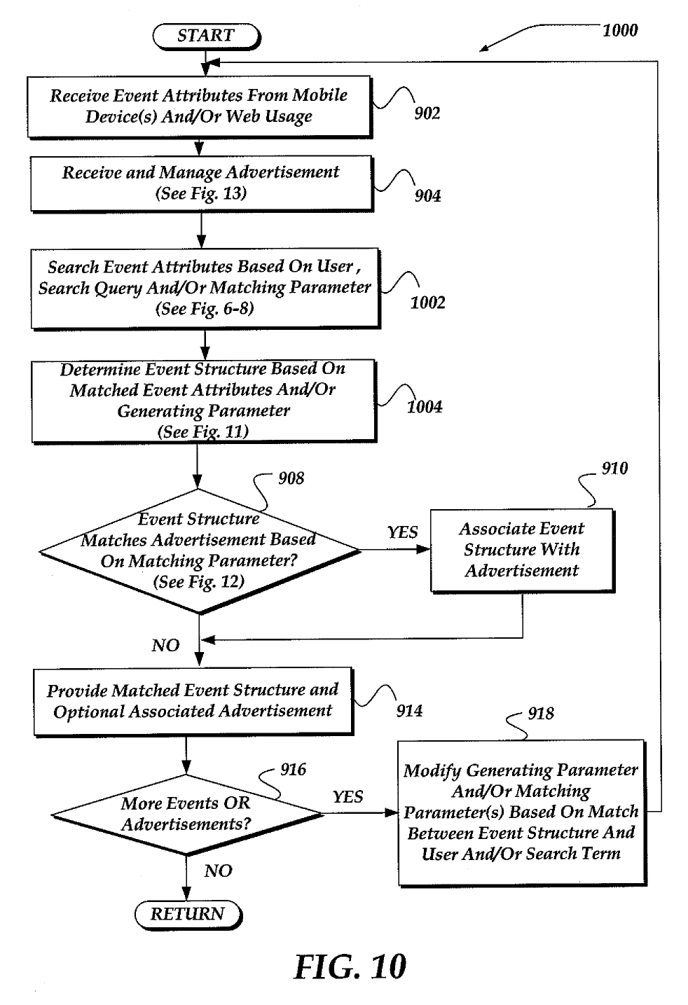

FIGS. 9-10 illustrate logical flow diagrams generally showing embodiments of processes for managing an event. Process 900-1000 of FIGS. 9-10 may be implemented by for example EME 112, content server 107, search server 106, and/or advertisement server 114 of FIG. 1.

Processing begins at block 902, where event attributes are received from at least one mobile device and/or at least one web usage. In one embodiment, the event attributes may comprise at least two of a temporal, spatial, social, or topical information from a client device and a web usage, about a state of the client device, a topical, time, or user of the web usage, or the like. In one embodiment, the client device may be a mobile device. In one embodiment, the state information of the client device may comprise a location (e.g., GPS coordinates), time, local time, identity of the user of the device, or the like. Web usage may comprise search terms, content of a web page visited, or the like.

At block 904, an advertisement is received and managed. Illustrative displays and a process for performing block 904 are described in more detail in conjunction with FIG. 13. Generally, managing the advertisement comprises providing a plurality of data about events, including event clusters, event groups, event bundles, or the like, providing analytics data about possible usage of advertisements/sponsorships and realizations from advertisements/sponsorships, receiving the advertisement (e.g., using an interface, over a network, or the like), associating the advertisement with an event attribute(s) or event structure, and modifying parameters such as biases or parameters for matching an advertisement with an event structure.

In one embodiment, analytics data may be generated based on the received event attributes. In one embodiment, the analytics data may comprise a conditional probability of events occurring or not occurring based on other events occurring or not occurring, a time series analysis showing when an event might likely occur, or the like.

In one embodiment, a purchase of the advertisement may be received. The purchase may be based on the analytics data and/or the generated event structure. In one embodiment, a payment for the advertisement may be received. The payment may cause biasing of a matching of the event structure with advertising attributes associated with the advertisement. In one embodiment, the payment may be received as part of a transaction comprising a sale, a bid, a reverse bid, a coupon redemption, or the like. In one embodiment, the advertisement attributes may be configured to include with a time greater than a current time of the transaction. That is, the event attributes are configured to match a future event. In an alternate embodiment, analytic data may be determined based on a pattern recognition of at least one event data point within the event attributes. The analytic data may be provided to an advertiser associated with the advertisement. A transaction may be received from the advertiser configured to associate the advertiser with one of the at least one event data point, event attribute, or the like.

In yet another embodiment, purchasing may comprise charging an event organizer a flat or sliding fee for creating an event, for event services requested, number of users or network activity before, during, or after an event (bandwidth-model), or the like. In another embodiment, an event organizer may enable a revenue sharing for a viewed/clicked-through or otherwise activated advertisement. For example, a revenue sharing may be opted into by the organizer for advertisements and/or sponsorship for the event. The revenue share amount may be based on network activities associated with the event, e.g. Social Halo, moderation, security, demos, or the like. At least a portion of the revenue share may be used to fund the creation of the event.

In one embodiment, the amount of the revenue share and/or the cost for creating the event may be pre-determined or dynamically determined. Dynamic determination includes altering pricing and delivery based upon e.g. time, location, association, or other data, bidding between sponsors for events, or the like.

At block 906, an event structure is determined, created, or otherwise generated based on the received event attributes and/or at least one generating parameter. The process for performing block 906 is described in more detail in conjunction with process 1100 of FIG. 11. Briefly, an event structure may be generated on-the-fly, pre-configured or the like. In one embodiment, determining the event structure may comprise configuring the fields of the event structure, enabling an operator, sponsor, attendee, or other user of the event to pre-fill at least some fields, biasing at least a portion of the fields of the event structure to store at least a portion of the event attributes that match a type of event information, enabling the biases for the fields to match topical s keywords, time ranges, people types (e.g., age, gender, relationship types), or the like.

In one embodiment, generating and/or determining may comprise clustering the event attributes into a plurality of clusters (e.g., based on a temporal, spatial, social, or topical dimension dimensionality), and/or storing each portion of the plurality of clusters into a different one of the fields of the event structure. In one embodiment, clustering may comprise k-means square, hierarchical clustering, neural network clustering, or the like. In one embodiment, generating and/or determining may comprise minimizing at least one distance measure between a first data point representing a first portion of the event attributes and a second data point representing a second portion of the event attributes. The first data point and the second data point may be included in an n-dimensional space representative of at least two of a temporal, spatial, social, or topical dimension. In one embodiment, generating and/or determining may comprise minimizing at least one of a probability of recurrence of points within an n-dimensional space comprising the event structure and another event structure, a spatial distance between at least two points comprising the spatial information, a distance within a social network between at least two members comprising the social information, a semantic distance between two topical s comprising the topical information, or the like.

At decision block 908, it is determined whether the generated event structure matches the advertisement based in part on a matching parameter. Block 908 may use process 1200 of FIG. 12. Briefly, in one embodiment, determining may comprise matching the event structure and the advertising data based in part on one of an intersection of the event attributes and the advertising attributes. In another embodiment, determining may comprise matching the event structure and the advertising data based in part on a distance measure between at least a portion of the event attributes and another portion of the advertising attributes. Processing then continues to block 910.

At block 910, the event structure is associated with the advertisement. The event structure may be associated with the advertisement within a data structure, stored in the same record, combined using a plurality of data combinations (e.g., encryption, compression), or the like. Processing then continues to decision block 912.

At block 912, a search for the event structure is performed based on attributes of the user, a search term, and/or a matching parameter. The matching parameter may be the same or a different matching parameter as the one used at block 908. Searching may be based on a variety of information retrieval processes, including term frequency, semantic matching, or the like. In one embodiment, matching may be based on clustered search processing as described in processes 600-800 of FIGS. 6-8.

Briefly, in one embodiment, a search query, including a search term may be provided by the user, generated for the user, provided by a client device, provided over a network, or the like. In one embodiment, matching the search query to at least one content or context information within the event structure (e.g., fields of the event structure) may be based on clustered search processing, or other information retrieval processes. The search query may comprise a search term provided by the user, determined based on attributes of the user, commonly searched term at a location of the user, or the like. In one embodiment, the search query may also comprise contextual information such as the user's temporal, spatial, social, or topical information.

In another embodiment, searching for the event structure comprises receiving a search query, searching a plurality of data sources based on the search query to produce a plurality of clusters of search results, wherein at least one of the plurality of clusters includes the event structure, determining a score for each of the plurality of clusters, ordering the plurality of clusters, and the like.

In one embodiment, block 912 may be performed periodically. In one embodiment, a client device may send the search query over a network. In another embodiment, a server device may periodically perform a search for the user/client device based on the user's profile (e.g., the user's temporal, spatial, social, or topical information). In any case, the matching event structure is determined based on a match of the attributes of the user, a search query, search term, and/or the event structure.

At block 914, the event structure and optionally an associated advertisement is provided. In one embodiment, providing may comprise sending the event structure, displaying the event structure, enabling an activation of the advertisement, and performing a revenue sharing or other financial transaction based on the activation.

In one embodiment, providing may comprise displaying at least one keyword associated with at least a portion of the event structure. In one embodiment, providing the event structure and/or associated advertisement comprises inviting at least one user to interact with, view, or activate at least a portion of the event information and the advertisement, wherein the user is associated with the event based on at least a portion of the event structure. Viewing and interaction may comprise viewing an identity and/or relationship of a user, a time information, a place information (e.g., weather or other environmental condition), time-span of the event, topical of the event, or the like. In another embodiment, providing may comprise sending a message in real-time to a (mobile) device of at least one user to view the event information. In one embodiment, the user receiving the event information may match the event attributes. In one embodiment, providing may be performed substantially in real-time. In one embodiment, providing may be performed at or near the time of the event (e.g., a simulcast).

In one embodiment, the event information may be provided before, during, and after an event, The event information may announce upcoming events, may be about an ongoing event matching the user, a search query/term, about who is attending, about how many attended, or the like. The event information may be provided as a synopsis of what occurred during the prior event (e.g., who attended, what was the outcome of the event), or the like. Information about attendees may be provided based on information about users associated with the event (e.g., contextual information: time, GPS location of mobile device, search activity on the mobile device at the event). Synopsis information may comprise information about the attendees, and other meta-data entered by users after the event ends (e.g., who one a race, a review of a movie).

In one embodiment, the advertisement is configured to provide a value exchange if the advertisement is activated. The value exchange may be monetary, credits, social recognition points, or the like. In one embodiment, the advertisement may be provided as a co-located banner ad, inserted into a presentation about the event, a sponsored search for the result, a microsite, or the like.

In one embodiment, a revenue is shared for the provided event information and associated advertisement. The revenue share may be provided to a user associated with the event, a user matching the event, or even a third-party. The revenue share may be based on a number of impressions viewed, clickthroughs, realizations on the advertisement (an actual buying of a product), or the like. In one embodiment, an amount proportional to a value exchange for activating the advertising may be provided as at least a portion of the revenue share.

At decision block 916, it is determined whether there are any pending event attributes and/or advertisements to be received. If there are pending event attributes and/or advertisements to be received, processing continues to block 918. If there are no pending event attributes and no advertisements to be received, processing returns to a calling process for further processing.

At block 918, the matching parameter(s) and or the generating parameter are modified based on the provided event structure and/or a search and/or match performed on the event structure. In one embodiment, at least one parameter for generating the event attributes or the advertising attributes may be modified based on an amount of use of the advertisement. The amount of use may comprise an amount of activation, realization, sharing, or the like.

In one embodiment, a user plurality of temporal, spatial, social, or topical information associated with a usage by a user of a client (mobile) device and a web usage may be received. The information may be received if the advertisement is activated by the user. A distance measure between at least one portion of the user plurality and at least one portion of the event attributes or at least one portion of the advertising attributes may be determined. At least one parameter for matching the event structure with the advertising attributes may be modified based on the distance measure. In one embodiment, modifying may comprise using supervised or unsupervised learning, A* hill-climbing, neural network, support vector machine, reinforcement learning, automatic time-series recurrence analysis, or the like. Processing then loops back to block 902 for further processing.

Process 1000 of FIG. 10 operates substantially similar to process 900, except in process 1000, the searching is not performed after decision block 908. Instead, after block 904, processing continues to block 1002, where a search is performed on event attributes. In one embodiment, searching may comprise receiving a search query, searching the event attributes based on the search query to produce a plurality of clusters of search results, determining a score for each of the plurality of clusters, ordering the plurality of clusters, configuring a plurality of combined event attributes of one of the plurality of clusters to be storable into the fields of the event structure, or the like.

Next, Block 1004 may operate substantially similarly to block 904 of FIG. 9, except, at block 1004, the event structure is generated based on the matched (searched for) event attributes. In one embodiment, the combined event attributes may be stored into the fields of the event structure. Processing then continues to block 908, similarly to process 900 of FIG. 9.

FIG. 11 illustrate a flow diagram generally showing an embodiment of generating an event structure based on event attributes. While FIG. 11 shows one embodiment for generating based on clustering, other embodiments for generating, such as filtering, rule based matching, or the like, may be used without departing from the scope of the invention. Process 1100 of FIG. 11 may be implemented by for example EME 112, content server 107, search server 106, and/or advertisement server 114 of FIG. 1.

Process 1100 begins with cluster 1102. As shown cluster 1102 may comprise a plurality of data points. Each data point may represent at least two of a temporal, spatial, social, or topical information. As shown 1102 comprises the following data points: <Jane, Soccer for Girls, Sat 9 AM-11:30 AM Recurring, Golden Gate Park SF>, <Bob, Beer, 9:30 PM Jan. 26, 2008, Sports Bar SF>, <Judy, Soccer Moms Drinks, Sat 9 AM-11 AM Recurring, Golden Gate Park SF>, and <Jack, Soccer AND Games, *********, *********>. Other data points may be included without departing from the scope of the invention. For example, a plurality of points for Judy may be included. In the example, Jane may be Judy's daughter. This social information may be included in a social network (e.g., with labeled directed links between members of the social network). Judy and Bob may be spouses. Jane may be Jack's classmate.

Each pair of data points may have a relationship and a relationship measure. For example, <Jane, . . . > is related to <Judy, . . . > by a relationship with a measure of 0.7. The measure may be high because it may be based on a close social distance between Jane and Judy (mother-daughter or parent-child relationship), a high semantic similarity in topical s associated with the members (e.g., the term “soccer” has been searched by both members), and/or a high temporal-spatial similarity (both members are near Golden Gate Park SF every Saturday around 9 AM-11 AM). Based on an aggregate similarity match between the data points, the measure 0.7 may be calculated. The aggregate may be a weighted sum, or the like. At least one generating parameter/bias may be used in the weighted sum. For example, relationships between family members may cause that factor to weigh more in the weighted sum.

As shown, <Jane, . . . > is related to <Bob, . . . > by a relationship with a measure of 0.3. This measure may be medium and may be lower than the Jane-Judy measure because, although Jane and Bob are related by the parent-child relationship, other portions of the data points do not match.

As shown, <Jane, . . . > is related to <Jack, . . . > by a relationship with a measure of 0.6. This measure may be higher than the Jane-Bob measure because at least two portions of the data points (e.g., social and topical information) match.

<Jack, . . . > is related to <Judy, . . . > by a relationship with a measure of 0.4. In this example, the measure may be medium because Jack and Judy may be a second degree of separation in a social network. The social relationship factor may be decreased proportional to the degree of separation. However, the topical “Soccer” matches between the data points.

<Jack, . . . > is related to <Bob, . . . > by a relationship with a measure of 0.1 and may be low because the only relationship between the data points is a second degree social relationship factor.

<Judy, . . . > is related to <Bob, . . . > by a relationship with a measure of 0.7 and may be high because of the close social relationship (husband-wife) and a match of the topical s (“Drinks” and “Beer”).

Based on the data points of cluster 1102 and the relationships between the data points, a plurality of clusters of data points may be generated. As shown, clusters 1104-1105 may be generated. Each cluster may include at least one data point. Data points may be shared between the clusters. Each cluster may be generated based on a clustering algorithm, including K-means clustering, Fuzzy c-means clustering, QT clustering, Hierarchical clustering, agglomerative clustering, unsupervised or semi-supervised learning, artificial neural networks, such as Kohonen maps, or the like.

As shown, cluster 1104 includes the data points <Jane, . . . >, <Judy, . . . >, <Jack . . . >. Cluster 1105 includes the data points <Bob, . . . > and <Judy, . . . >.

While only one level of clustering is shown, hierarchical clustering may also be used. For example, cluster 1104 may be sub-clustered, and so forth.

At least one cluster may be used to generate an event structure. As shown, an event structure may comprise with fields associated with a different one of a temporal, spatial, social or topical dimension. For example, event structures 1106-1107 comprise the fields Who (social), What (Topic), When (Temporal), and Where (Spatial). Event structures 1106-1107 may comprise more or fewer fields without departing from the scope of the invention. At least one cluster may be used to generate at least one event structure. As shown, cluster 1104 may be used to generate event structure 1106 and cluster 1105 may be used to generate cluster 1107.

The generation of an event structure from a cluster may comprise matching, filtering, field biasing/constraining, aggregation, intersection, or the like. As shown, at least one portion of the data points corresponding to at least one dimension associated with a field may be aggregated and stored into the field. For example, the Who(Spatial) field of event structure 1106 aggregates the members Jane, Judy, and Jack from the social portion of the data points.

An intersection may also be used to generate and store data into a field. For example, the What (topic) field of event structure 1106 comprises the term “Soccer” which may be a lexical intersection between the topical portions of the data points (e.g., all members searched for the term “Soccer”). In another embodiment, the intersection may be based on a semantic relationship, such as an ontology, or the like. For example, all members searched for different types of sports.

Each field may also include at least one generating parameter/bias. As shown, the what (topic) field may include a bias for the term or concept “Sports” or “Kids.” The bias may cause generation from clusters which comprise points with a higher relationship to the terms and/or generated with a bias for the terms. Alternately, data points that match the bias from a cluster may be filtered based on the bias. For example, data points with portions that match “Sports” or “Kids” may be selected for generating event structure 1106.

At least some fields may be an average, maximum, minimum, or other mathematical function of values from the data points. For example, the time span Sat 9 AM-11 AM is a minimum between the <Jane, . . . > and <Judy, . . . > data point. As shown, some data points (e.g., <Jack, . . . >) may not have some fields provided. In this case, the fields may use default data or no data. As shown, because <Jack, . . . > have no temporal data, and the data points <Jane, . . . >'s and <Judy, . . . >'s temporal information is used to generate the When (Temporal) field for event structure 1106.

At least some fields are generated based on a match of portions of data points. For example, the Where (Spatial) field of event structure 1106 is generated with at least some spatial portions of data points of cluster 1104 (e.g., Golden Gate Park, SF, CA).

In one embodiment, the process for generating the fields for an event structure may be configurable, pre-determined, determined at run-time, or the like. In one embodiment, the generating parameters/biases may be modified based on a feedback as described, for example, in block 918 of FIGS. 9-10.

FIG. 12 illustrate a flow diagram generally showing an embodiment of matching an advertisement to an event structure. Process 1200 of FIG. 12 may be implemented by for example EME 112, content server 107, search server 106, and/or advertisement server 114 of FIG. 1.

As shown, advertisements 1202-1203 may be configured with a plurality of fields associated with a plurality of event attributes, event biases/parameters, or the like. Advertisement 1202 includes a Who (Social) field bias that constrains matches to social relations of parent-child and wherein the number of attendees is greater than 10. The What (topical) field is biased or biased to the concept of “Sports.” The When (temporal) field is not biased. The Where (spatial) field is biased to be in California.

Advertisement 1203 includes Who (social) field biased to ages 24-45, What (topical) field biased to drinks, and Where (spatial) field biased to California. Other fields, biases/parameters may be used without departing from the scope of the invention.

A match of advertisements 1202-1203 with event structure 1106. As shown, event structure 1106 may be identified by the term “Soccer” which may be derived from its What (topical) field. As shown, advertisement 1202 is related to event structure 1106 by a relationship of 0.6 strength, while advertisement 1203 is related to event structure 1106 by a relationship of 0.1 strength. The strength or value of the relationship may be determined by a similarity between the matching fields between the advertisements and event structure (Who to Who field, What to What field, etc.). The similarity measure may be substantially the same similarity measure as used in process 1100 of FIG. 11 in determining the similarity between data points of clusters 1102, 1104, and 1105.

FIG. 13 illustrate a flow diagram generally showing an embodiment for managing advertisements for events. While FIG. 13 shows one order for using the displays 1300, 1320, and 1350, other ordering of the displays may be used without departing from the scope of the invention. The process of FIG. 13 may be implemented by for example EME 112, content server 107, search server 106, advertisement server 114, or clients 101-104 of FIG. 1.

The process begins at display 1300 where a sponsor is enabled to register to sponsor at least one existing event. In one embodiment, the existing events may be determined using process 1100 of FIG. 11, or may be pre-configured. The sponsor may choose to sponsor the event by activating buttons 1310-1311. Activating buttons 1310-1311 may generate an advertisement that matches the selected event. For example, activating button 1311 may create an advertisement that matches the fields of event structure 1106 of FIGS. 11-12. The sponsor may also be enabled to modify the fields by changing the biases of the fields. For example, the sponsor may be enabled to configure the fields to create advertisement 1202. The sponsor may also be enabled to purchase the advertisement, through payment, bidding, or any other transaction. The sponsor may also configure advertising parameters such as duration of the advertisement campaign, or the like.

The sponsor may also choose to create their own events by activating button 1312. Activating button 1312 may enable the sponsor to create at least one event attribute and/or event structure as described in process 1100 of FIG. 11. The sponsor may bias at least one field of the created event structure. The sponsor may choose to create an advertisement not currently associated with an event. The created advertisement may match an event when appropriate event attributes/event structures are determined.

The process next continues to display 1302 where a summary of a plurality of advertisements 1304 associated with the sponsor are managed, with each advertisement matching at least one event. Advertisements 1304 may comprise the data structures of events 1202-1023 of FIG. 12, for example. As shown, the “Sports” advertisement may match an event that comprises event attributes similar to the “Sports” advertisement. In this case, the “Sports” advertisement matches the “Soccer in Golden Gate Park” event. The title for the event may comprise any combination of the keyword (e.g., from the What (topical) field), location, time, or the like. Also as shown, the “Drinks” event matches the “Beer at SF Sports Bar” event. Advertisements 1304 may be associated with advertising parameters and results 1302. As shown, advertising parameters and results 1302 show that the “Sports” advertisement will run 15 months, has received 10 clickthroughs, and 100 views, and costs $0.02 per clickthroughs and $0.01 per view. Advertising parameters and results 1302 also show that the “Drinks” advertisement will run for 13 months, has received 4 clickthroughs, and 5 views, and costs $0.05 per clickthroughs and $0.05 per view. The sponsor may manage or otherwise edit the advertising parameters and results 1302 or the event attributes of advertisements 1304 by activating buttons 1314-1315.

The process next continues to display 1350 where analytics data about past and projected performance for an advertisement are shown. While display 1350 shows a % realization (e.g., sales due to advertisement/viewed advertisement or sales due to advertisement/clickthrough), other statistical data about advertisements may also be presented. As shown, advertisements line graph 1354 shows the actual realizations for November 2007 to January 2008. This portion of the graph may be based on collected data. Advertisements line graph 1354 also shows projected realizations for the next month. This portion may be based on a plurality of information, including past performance for the advertisements, similar advertisements, or all advertisements for similar periods of times (same months), past performance for the sponsor, or the like. Using the analytics data, the sponsor may choose to manage or otherwise modify their advertisements. Accordingly, processing may loop back to display 1300 or 1320 for further processing.

FIG. 14 illustrate a flow diagram generally showing an embodiment providing event information. While FIG. 14 shows one order for using the displays 1400, 1450, and 1480, other ordering of the displays may be used without departing from the scope of the invention. The process of FIG. 14 may be implemented by for example EME 112, content server 107, search server 106, advertisement server 114, or clients 101-104 of FIG. 1.

The process begins at display 1400 where a user is enabled to search for at least a matching event. Display 1400 may be a display on a mobile or non-mobile device. As shown, display 1400 may include attributes 1410 about the user/device. The attributes 1410 may be stored in a cookie, sent over a network, determined by an IP address, local current time, GPS processes, or the like. The user is enabled to enter a search term in entry 1404. As shown, the user may enter the term “soccer.” The search term may be used to search for event attributes/event structures as described in process 900-1000 of FIGS. 9-10. At least one matching event and/or other search results 1412 from matching content may be returned. For example, events/results 1412 that match the term “soccer” and/or attributes 1410 are returned. Events/results 1412 may include a description of the event and/or the relationship or match to the user. For example, events/results 1412 show the time until the event start, the spatial distance from the user's current location to the event's location, and the relationship of the user to a person associated with the event (e.g., attendee). Events/results 1412 also shows other matching content (e.g., web content), which may also include sponsored search results. Moreover, matching advertisements 1406 may also be displayed. The advertisements 1406 may be matched to the matching events/results 1412 by process 1200 of FIG. 12. Advertisements 1406 may be ordered based on strength of match, payment amount paid by an advertiser/sponsor, or the like.

The process next continues to display 1450 where an event is selected and information about the event is shown. Display 1450 includes summary 1414 of the event's attribute or the fields of an associated event structure. Summary 1414, for example, shows the term “Soccer” associated with the event, the time, place of the event, and whether the event is recurring. Advertisements 1407 that matches the displayed event may also be shown. Users 1420-1424 associated with the event (e.g., attendees, participants, sponsors, facilities) may also be shown. Users 1420-1424 may exist in a social network. Users 1420-1424 may be shown as a graph of interconnected labeled relationships (e.g., a social network or a subset of a social network to which users 1420-1424 belong). For example, the graph may begin with user 1420 (the user requesting display 1450), continue to another attendee user 1421 (e.g., a child of user 1420), to user 1422 (e.g., a classmate of user 1421), to user 1423 (e.g., a parent of user 1422), and finally to user 1424 (a connection with user 1423 by at least one degree of separation in a social network). At least one of the users may be a sponsor (e.g., pay to be shown on the display). For example, user 1424 may pay to be shown, along with details about the sponsor. Clicking on any of users 1420-1424's icons provides additional information about the user.

The process next continues to display 1480 where information about an event is displayed based on attributes of the user and/or the device of the display. As shown, display 1400 may include attributes about the user/device 1416. As shown, the display may be of a device that is at or near the event matching the attributes 1416. Attributes may also show the amount of users at the event. The matching event may be combined with attributes 1416. For example, “Your Location” may show that the user/user's device is at the “Soccer” event. Other events and/or results 1418 that match attributes 1416 may also are displayed. Advertisements 1408 that match attributes 1416 and/or the currently attended event (e.g., “Soccer”) may also be shown. The match may also be based on search terms searched by other users at the event, or otherwise associated with the users at the event (e.g., “Drinks” may be searched by other users).

Other displays that may be shown without departing from the scope of the invention may also be shown, combined, or separate from displays 1400, 1450, and 1480. Other processes performed on event attributes/event structures and provided displays may include, but are not limited to:

| Matchmaking | Attention ranking | Event Results |
|---|---|---|
| Schedule/simulcast | Social Halo | Exhibit Content |
| Event People Results | “Local” Search | specialized |
| | | content |
| Real time AR | Premium add ons | People maps/event |
| | | maps |
| Live event | Schedule and | Exhibitor/sponsor |
| coverage/search | proceedings search | data |
| Exclusive rank only site | Games/interactive | Social network |
| only | | lists |
| Commerce Programs | Sponsor search | Funnel content |
| Content relations | One-click search | Commerce/content |
| | | manager |

As used herein, the term “attention ranking” refers to determining importance of a spatial location based on web rankings about the location (number of web pages about the location, links to pages about the location) and a recurrence of locations of mobile devices at or near the spatial location. Events may be displayed with an attention ranking factor.

As used herein, the term “social halo” refers to determining at least one live contact (e.g., a person in the user's social network) associated with an item, and displaying an icon co-located with the item, wherein the icon is enables communication to the contact. Events may be displayed with an icon to contact a friend (e.g., first or second degree link in the user's social network) who is an expert on the subject of the event (e.g., a soccer expert).

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent is:

1. A network device for communicating data over a network comprising:
a transceiver for communicating data; and
a processor configured to perform actions comprising:
receiving event attributes comprising at least two of a temporal, spatial, social, or topical information;
generating an event structure comprising fields associated with a different one of a temporal, spatial, social, or topical dimension based on the received event attributes; and
receiving advertising attributes about an advertisement, wherein the advertising attributes comprise at least two of another temporal, spatial, social, or topical information;
if the event structure matches the advertising attributes:
providing the advertisement co-located with the event structure, wherein the advertisement is configured to provide a value exchange if the advertisement is activated.

2. The network device of claim 1, wherein the actions further comprises:
receiving a search query, before providing the advertisement;
searching a plurality of data sources based on the search query to produce a plurality of clusters of search results, wherein at least one of the plurality of clusters includes the event structure;
determining a score for each of the plurality of clusters; and
ordering the plurality of clusters.

3. The network device of claim 1, wherein the actions farther comprises:
receiving a search query, before generating the event structure;
searching the event attributes based on the search query to produce a plurality of clusters of search results;
determining a score for each of the plurality of clusters;
ordering the plurality of clusters; and
configuring a plurality of combined event attributes of one of the plurality of clusters to be storable into the fields of the event structure.

4. The network device of claim 1 wherein the actions further comprises:
biasing at least a portion of the fields of the event structure to store at least a portion of the event attributes that matches a type of event information.

5. The network device of claim 1, wherein the actions further comprises:
inviting at least one user to interact with at least a portion of a display of the event information and the advertisement, wherein the user is associated with the event based on at least a portion of the event structure.

6. The network device of claim 1, wherein the event attributes are based on at least one state information about at least one mobile device and a web usage

7. The network device of claim 1, wherein generating further comprises:
clustering the event attributes into a plurality of clusters; and
storing each portion of the plurality of clusters into a different one of the fields.

8. The network device of claim 1, wherein generating further comprises:
minimizing at least one distance measure between a first data point representing a first portion of the event attributes and a second data point representing a second portion of the event attributes, wherein the first data point and the second data point is included in an n-dimensional space representative of at least two of a temporal, spatial, social, or topical dimension.

9. A mobile device for communicating data over a network comprising:
a transceiver for communicating data; and
a processor configured to perform actions comprising:
sending event attributes comprising at least two of a temporal, spatial, social, or topical information about the mobile device and a web usage;
sending a request for an event structure comprising fields associated with a different one of a temporal, spatial, social, or topical dimension based on the received event attributes; and
if the event structure matches advertising attributes:
receiving the advertisement co-located with the event structure, wherein the advertisement is configured to provide a value exchange if the advertisement is activated on the mobile device.

10. The mobile device of claim 9, wherein the actions further comprises:
receiving an invitation to interact with at least a portion of a display of the event structure and the advertisement, if a user associated with the mobile device matches the event structure.

11. The mobile device of claim 9, wherein providing the advertisement further comprises:
displaying at least one keyword associated with at least a portion of at least one of the event structure

12. The mobile device of claim 9, wherein the actions further comprises:
receiving at least a portion of the value exchange based on the event structure.

13. A method communicating data over a network comprising:
receiving event attributes comprising at least two of a temporal, spatial, social, or topical information from a client device and a web usage;
generating an event structure comprising fields associated with a different one of a temporal, spatial, social, or topical dimension based on the received event attributes;
receiving advertising attributes about an advertisement, wherein the advertising attributes comprise at least two of another temporal, spatial, social, or topical information; and
if the event structure matches the advertising attributes:
providing the advertisement co-located with the event structure, wherein the advertisement is configured to provide a value exchange if the advertisement is activated.

14. The method of claim 13, further comprising:
if the event structure matches a search term:
providing the event information and advertising information with at least another event information as an ordered search result.

15. The method of claim 13, further comprising:
providing a revenue share of the value exchange to a user matching the event structure.

16. The method of claim 13, her comprising:
minimizing at least one of a probability of recurrence of points within an n-dimensional space comprising the event structure and another event structure, a spatial distance between at least two points comprising the spatial information, a distance within a social network between at least two members comprising the social information, or a semantic distance between two topical s comprising the topical information.

17. The method of claim 13, further comprising:
matching the event structure and the advertising data based in part on one of an intersection of the event attributes and the advertising attributes.

18. A system for communicating data over a network comprising:
an Event Matching Engine (EME) configured to perform actions comprising:
receiving event attributes comprising at least two of a temporal, spatial, social, or topical information;
generating an event structure comprising fields associated with a different one of a temporal, spatial, social, or topical dimension based on the received event attributes;
receiving advertising attributes about an advertisement, wherein the advertising attributes comprise at least two of another temporal, spatial, social, or topical information; and
if the event structure matches the advertising attributes:
providing to the client device the advertisement co-located with the event structure, wherein the advertisement is configured to provide a value exchange if the advertisement is activated; and
a client device configured to perform actions comprising:
sending event attributes based on a state of the client device, a web usage on the client, or information about a user of the client device;
sending a request for the event structure; and
receiving the advertisement co-located with the event structure.

19. The system of claim 18, wherein the EME is further configured to perform actions comprising:
matching the event structure and the advertising data based in part on a distance measure between at least a portion of the event attributes and another portion of the advertising attributes.

20. The system of claim 18, wherein the EME is further configured to perform actions comprising:
modifying at least one parameter for generating the event attributes or the advertising attributes, based on an amount of use of the advertisement.

21. The system of claim 18, wherein the EME is further configured to perform actions comprising:
receiving a payment for the advertisement; and
biasing, in response to the payment, the matching of the event structure with the advertising attributes.

22. The system of claim 18, wherein the EME is further configured to perform actions comprising:
determining analytic data based on a pattern recognition of at least one event data points within the event attributes;
providing the analytic data to an advertiser associated with the advertisement; and
receiving a transaction from the advertiser configured to associate the advertiser with one of the at least one event data points.

23. A processor readable medium comprising instructions executable by a processor to perform actions, comprising:
receiving event attributes comprising at least two of a temporal, spatial, social, or topical information from a client device and a web usage;
generating an event structure comprising fields associated with a different one of a temporal, spatial, social, or topical dimension based on the received event attributes;
receiving advertising attributes about an advertisement, wherein the advertising attributes comprise at least two of another temporal, spatial, social, or topical information; and
providing the advertisement co-located with the event structure. if the event structure matches the advertising attributes.

24. The processor readable medium of claim 23, wherein the actions further comprises:
receiving a search query, before providing the advertisement;
searching a plurality of data sources based on the search query to produce a plurality of clusters of search results, wherein at least one of the plurality of clusters includes the event structure;
determining a score for each of the plurality of clusters; and
ordering the plurality of clusters.

25. The processor readable medium of claim 23, wherein the actions further comprises:
receiving a search query, before generating the event structure;
searching the event attributes based on the search query to produce a plurality of clusters of search results;
determining a score for each of the plurality of clusters;
ordering the plurality of clusters; and
configuring a plurality of combined event attributes of one of the plurality of clusters to be storable into the fields of the event structure.
